(19) United States
(12) Patent Application Publication
(10) Pub. No.: US 2023/0049571 A1
(43) Pub. Date: Feb. 16, 2023

(54) Display Height Adjust Stand in Compact Form Factor

(71) Applicant: Dell Products L.P., Round Rock, TX (US)

(72) Inventors: Derric C. Hobbs, Round Rock, TX (US); Tzu-wei Tai, Taipei City (TW)

(73) Assignee: Dell Products L.P., Round Rock, TX (US)

(21) Appl. No.: 17/401,417

(22) Filed: Aug. 13, 2021

(51) Int. Cl. F16M 11/24; F16M 11/10; G06F 1/16

(52) U.S. Cl. CPC F16M 11/24; F16M 11/10; G06F 1/16

(57) ABSTRACT

Described are a height adjust stand (HAS) for a display and an all in one computing device. The HAS includes a base. A riser assembly connects to the base, and angled greater than 90 degrees from vertical of the HAS. A lift plate in the riser assembly that includes an arm, the arm angled greater than 90 degrees from vertical of the HAS. The lift plate provides vertical travel for the display. A VESA assembly includes a mating component that fits into the opening of the arm. The VESA assembly including an internal hinge that provides tilt for the display. In an all in one computing device, a computing cartridge assembly is snapped into the back of the riser assembly.

### BACKGROUND OF THE INVENTION

### Field of the Invention

The present invention relates to the stands of displays. More specifically, embodiments of the invention provide a compact form factor height-adjust or adjustable stand (HAS) that can support various displays and computing devices.

### Description of the Related Art

Stands that support displays, such as computer displays or monitors, can be implemented for use for a different sizes of displays. The range of the different sizes of displays varies depending on how a stand is configured. A stand can be height adjustable, referred to as a height-adjust stand or HAS. A HAS stand allows vertically travel to support different size displays and can allow a user to move the display into a desirable position (i.e., portrait or landscape positions).

Freestanding HAS stands can have a base that rests on a working area. The base can be attached to a vertical support structure, which can be connected to a horizontal structure. The horizontal structure can be connected to a structure or assembly that attaches to a display. The structure or assembly that connects to the display can implement industry mounting standards, such as VESA (video electronics standards association) to connect with various displays.

Typical stands are designed to address structural support of displays. It may only be a secondary consideration as to providing a compact and aesthetically pleasing stand. The main purpose of a stand is to provide structurally support. A compact and aesthetically pleasing stand still needs to provide structural support. In certain instances, an attached display can experience a wobble when tilted or adjusted. A stand should consider eliminating such wobbles. In certain implementations “all in one” computers (i.e., information handling devices) are supported by a stand. In such implementations, consideration should be made as to integrating computing components in the stand.

### SUMMARY OF THE INVENTION

A height adjustable stand (HAS) for a display is described herein. The HAS includes a base; a riser assembly connected to the base, wherein the connection is angled greater than 90 degrees from vertical of the HAS; a lift plate in the riser assembly that includes an arm, wherein the arm is angled greater than 90 degrees from vertical of the HAS, the lift plate providing vertical travel for the display; and a VESA assembly that includes a mating component that fits into the opening of the arm, the VESA assembly including an internal hinge that provides tilt for the display.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1A illustrates a side view of a compact form factor height-adjustable stand (HAS) that supports various displays and computing devices;

FIG. 1B illustrates an exploded side view of a compact form factor height-adjustable stand (HAS) that supports various displays and computing devices;

FIG. 2 illustrates an exploded rear right side view of a compact form factor height-adjustable stand (HAS) that supports various displays and computing devices;

FIG. 3 illustrates a front left side view of a compact form factor height-adjustable stand (HAS) that supports various displays and computing devices;

FIG. 4A illustrates a front left side view of a compact form factor height-adjustable stand (HAS) with a VESA assembly at the top of a riser assembly;

FIG. 4B illustrates a front left side view of a compact form factor height-adjustable stand (HAS) with a VESA assembly at the bottom of a riser assembly;

FIG. 5A illustrates a front right side view of an exposed riser assembly with a lift plate at the top position;

FIG. 5B illustrates a front right side view of an exposed riser assembly with a lift plate at the bottom position;

FIG. 5C illustrates a left plate;

FIG. 6A illustrates a back left side view of a VESA assembly;

FIG. 6B illustrates a front right side view of a VESA assembly;

FIG. 7 illustrates a cross sectional view of an angled arm and VESA hinge bar;

FIG. 8A illustrates a crossing sectional view of a VESA assembly in an unlock position;

FIG. 8B illustrates a cross sectional view of VESA assembly 110 in a lock position;

FIG. 8C illustrates a rear view of a section of a VESA assembly with a lock and unlock positions for display rotation;

FIG. 8D illustrates a rear view of a section of a VESA assembly with a set screw in a lock position;

FIG. 8E illustrates a rear view of a section of a VESA assembly with a display rotation locking slot;

FIG. 8F illustrates a rear view of a VESA assembly with a display rotation locking slot;

FIG. 9A illustrates a front view of a section of a riser assembly that includes a rectangular pass through slot;

FIG. 9B illustrates a front view of a section of a riser assembly that includes a rectangular pass through slot and various interconnections;

FIG. 9C illustrates a front exposed view of a section of a riser assembly that includes a dongle for wireless communication; and

FIG. 9D illustrates a cross sectional view of a section of a riser assembly with a dongle, wireless communication, and airflow.

### DETAILED DESCRIPTION

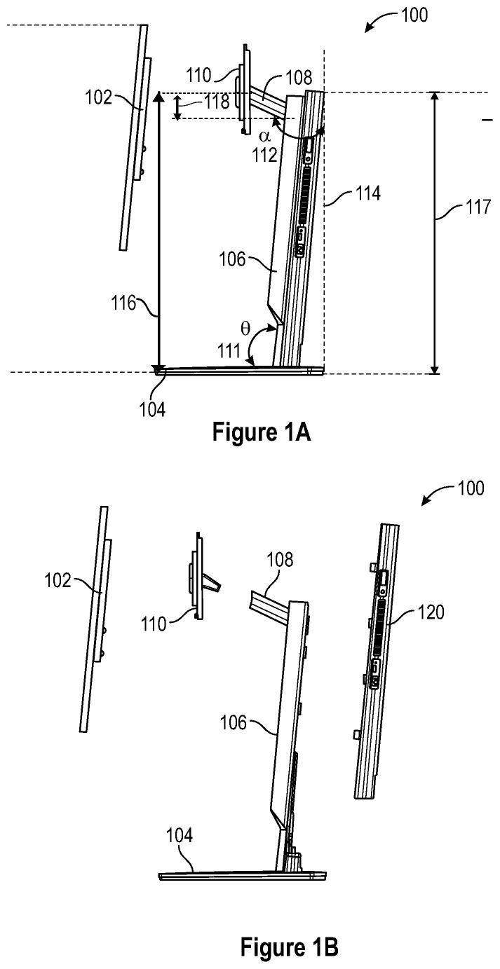

FIG. 1A shows a side view of a compact form factor height-adjust stand (HAS) that supports various displays and computing devices. A compact form factor HAS stand 100 connects with various displays 102. The HAS stand includes a base 104, a riser assembly 106, an angled arm 108, and a VESA assembly 110. In certain implementations, the riser assembly 106 is angled at θ 111 in respect to the base 104. An example of θ 111 is 95 degrees.

Implementations provide for the angled arm 108 to be angled at a 112 from vertical 114, where a 112 is greater than 90 degrees. An example of a 112 is 95 to 130 degrees.

By providing angle θ 111 greater than 90 degrees, a greater vertical structural support for HAS stand 100 can be realized. Height 116 is measured from base 104 to the center of VESA assembly 110.

If the angle a 112 is greater than 90 degrees (i.e., a horizontal angle arm 108), additional vertical travel for HAS stand 100 can be realized without increasing height 117. For example, if a 112 is 110 degrees, an additional 35 mm of vertical travel as shown by 118 can be provided without increasing the height 117 Furthermore, as further discussed herein, a mating component can be part of the VESA assembly 110. The mating component is inserted into the angled arm 108 and can be secured with a set screw. Because of gravitational weight, an angle a 112 of about 110 degrees can assure that the VESA assembly 110 stays in position before secured with the set screw.

Various embodiments provide for the different size or heights 116 and 117 of compact form factor HAS stand 100 to support different sized displays. For example, one size compact form factor HAS stand 100 can support displays diagonally measured from 19″ to 27″ with a maximum weight of 5.7 kg. The height 116 of such compact form factor HAS stand 100 can be about 360. Another larger size compact form factor HAS stand 100 can support displays diagonally measured from 30″ to 40″ with a maximum weight of 10.5 kg. The height 116 of such compact form factor HAS stand 100 can be about 415.

Various implementations provide for the VESA assembly 110 to include an internal hinge (not shown). Implementations provide for the internal hinge to support plus or minus tilt of display 102, such as a plus 21 degree and minus 5 degree tilt of the display 102. The internal hinge is further described herein.

FIG. 1B shows an exploded side view of a compact form factor height-adjust stand (HAS) 100 that supports various displays and computing devices. In certain embodiments, the HAS stand 100 supports “all in one” computers (i.e., information handling systems), where hardware resources are included in one standalone unit. Various embodiments, provide for a computing cartridge assembly 120 to be attached to the riser assembly 106 of HAS stand 100.

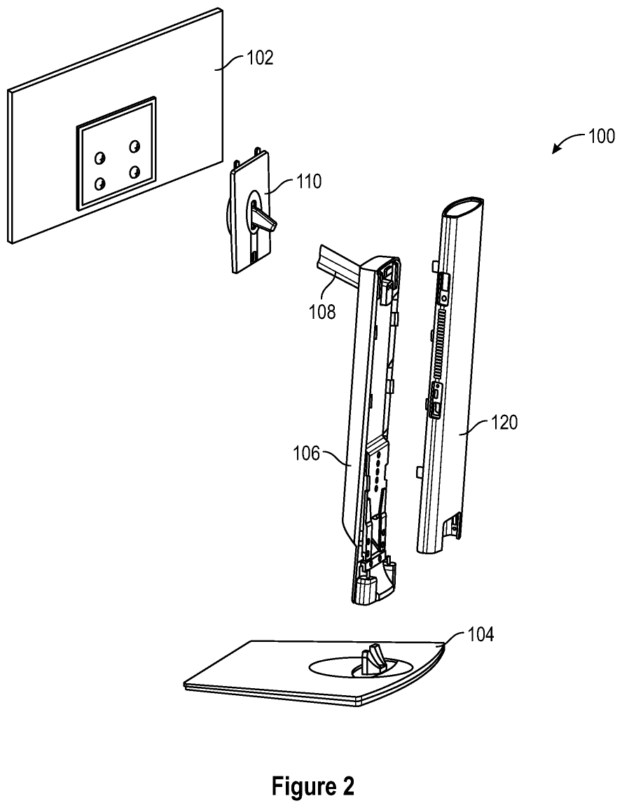

FIG. 2 illustrates an exploded rear right side view of a compact form factor height-adjust stand (HAS) 100. FIG. 2 shows that the base 104 can be separated from riser assembly 106. The computing cartridge assembly 120 can be attached into the riser assembly 106. By incorporating a modular design approach to HAS stand 100, where there are separate base 104, riser assembly 106, VESA assembly 110, and cartridge assembly 120, upgrades can be facilitated. For example, base 104 and VESA assembly 110 can be changed to support heavier displays 102, without the need to change the riser assembly 106 and cartridge assembly 120.

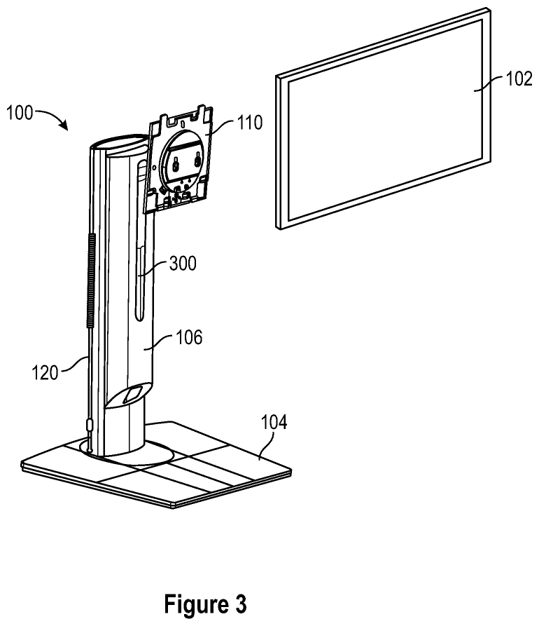

FIG. 3 illustrates a front left side view of a compact form factor height-adjust stand (HAS) 100 that supports various displays and computing devices. The HAS stand includes a lift plate 300 that is internal to the riser assembly 106. The lift plate 300 is a structural piece that allows the display to move vertically. For example, with one size HAS stand 100 can support 150 mm vertical travel. Another larger size HAS stand can support 170 mm vertical travel.

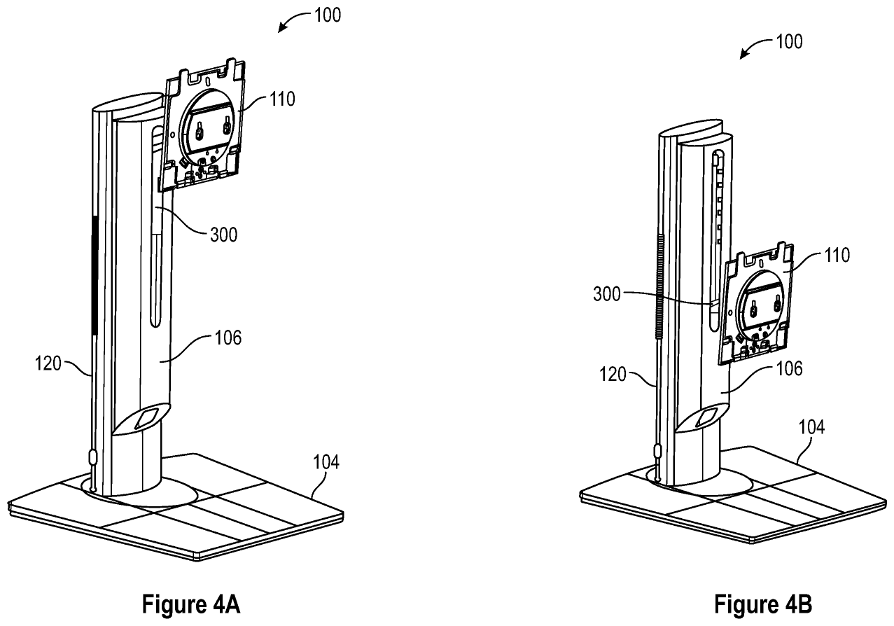

FIG. 4A shows a front left side view of a compact form factor height-adjust stand (HAS) 100 with VESA assembly 110 at the top of a riser assembly 106. Lift plate 300 is at its highest point in supporting display 102.

FIG. 4B shows a front left side view of a compact form factor height-adjust stand (HAS) 100 with VESA assembly 110 at the bottom of a riser assembly 106. Lift plate 300 is at its lowest point in supporting display 102.

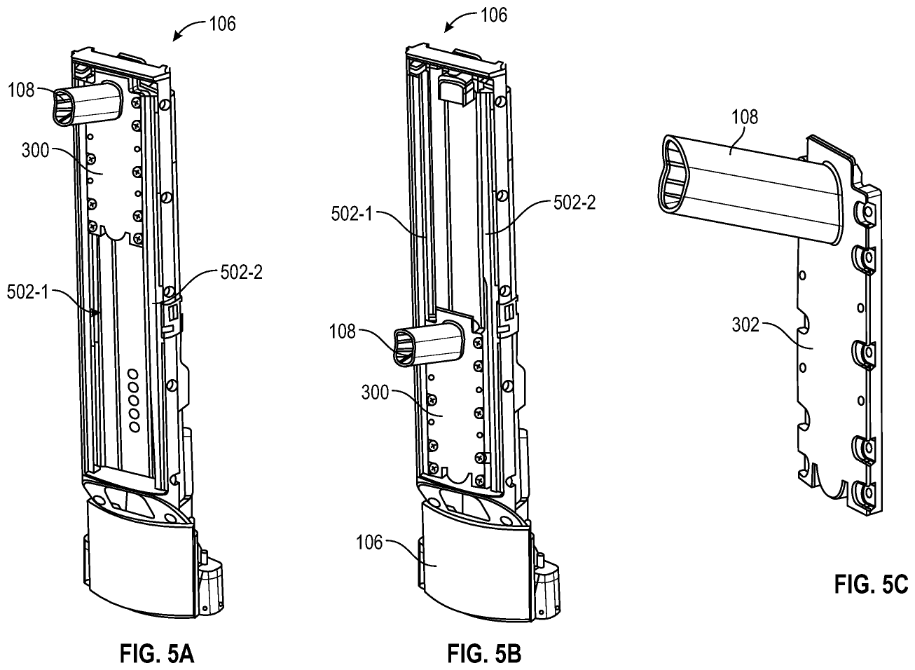

FIG. 5A shows a front right side view of exposed riser assembly 106 with a lift plate 300 at the top position. In various implementations, a cover (not shown) is provided on the front the riser assembly 106. When the cover is removed, the lift plate 300 is shown. Lift plate 300 includes the angled arm 108. In various implementations, the lift plate 300 travels along rails 502-1 and 502-2 which are internal to riser assembly 106. Implementations can provide for lift plate to be assisted, such as by spring assist, to travel vertically along rails 502-1 and 502-1. The position of the lift plate 300 is the highest position provided for a display 102.

FIG. 5B shows a front right side view of exposed riser assembly 110 with lift plate 300 at the bottom position. The position of the lift plate 300 is the lowest position provided for a display 102.

FIG. 5C shows the lift plate 300. Lift plate 300 includes the angled arm 108 which includes an opening to accept a mating component of the VESA assembly 110.

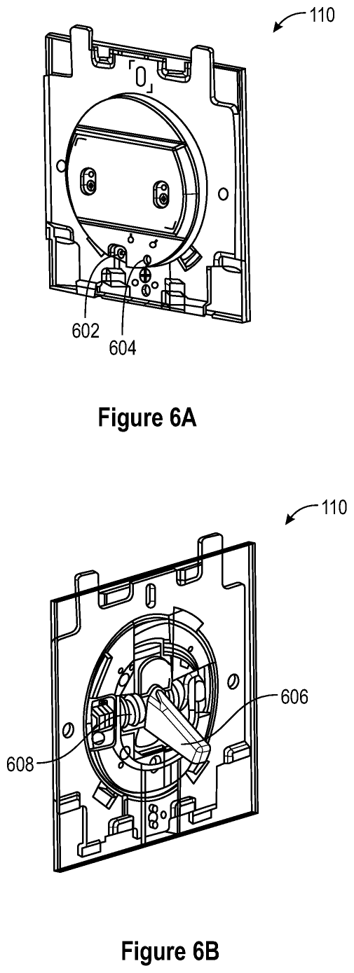

FIG. 6A shows a back left side view of VESA assembly 110. In certain embodiments, the VESA assembly includes a rotational lock that limits display 102 rotation. An example maximation rotation can be plus or minus four degrees for 32 inch and larger displays. Embodiments provide for the VESA assembly to include a screw location 602 for a locked option and a screw location 604 for an unlocked option.

For various implementations, the locked position (i.e., screw location 602) is supported when the display 102 is in landscape orientations. A set screw protrudes through a pivot bracket cover, pivot bracket, front pivot ring and VESA bracket (all not shown) of the VESA assembly 110 and is threaded into the pivot bracket. The combination of the set screw protruding through these different components and interfacing with an angled slot on the VESA Bracket can restrict rotation of the display 102 to a maximum of plus or minus four degrees.

FIG. 6B shows a front ride side view of VESA assembly 110. Implementations provide for the VESA assembly 110 to include a mating component 606 that is inserted into hinged angled arm 108 and secured with a set screw. Such a configuration can allow serviceability when removing the VESA assembly 110, and allow upgrades of VESA assemblies, such as dual VESA assemblies. As discussed, implementations provide for the VESA assembly 110 include an internal hinge 608, where the internal hinge 608 can support plus or minus tilt of the display 102, for example plus 21 degree and minus 5 degree tilt. When connected to the VESA assembly 110, the hinged angled arm 108 becomes “hinged.”

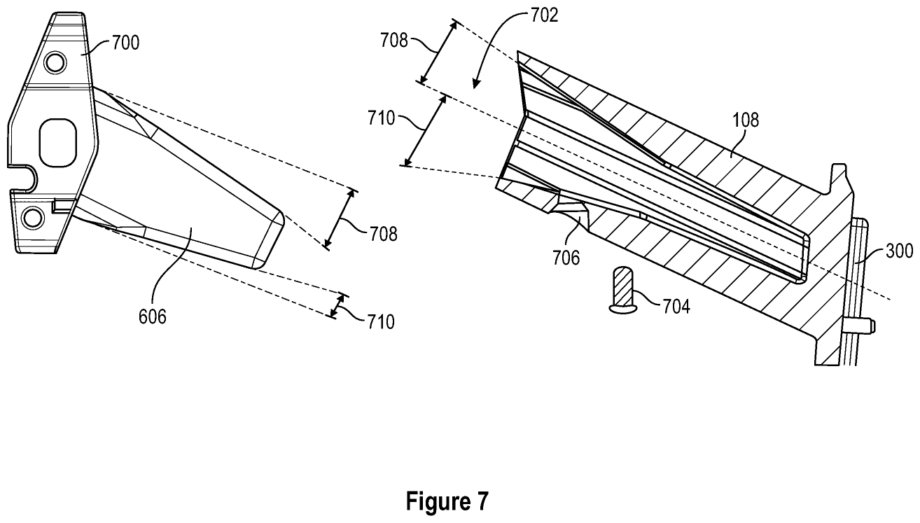

FIG. 7 shows a cross sectional view of hinged angled arm 108 and VESA hinge bar 700. The VESA hinge bar 700 is connected to the internal hinge 608. Mating component 606 is attached or is part of the VESA hinge bar 700. As discussed, when the mating component 606 is inserted into hinged angled arm 108. The mating component 606 and the VESA assembly 110 can be secured with a set screw 702 that is secured into place through an opening 704. A line to line fit for mating component 606 and the opening of hinged angled arm 108 is possible by providing angling surfaces. The internal (i.e., opening) of hinged angle arm 108 corresponds with the external surfaces of the mating component 702, as represented by angles 706 and 708. An example value of angles 706 and 708 is nine degrees.

In order to prevent display 102 from wobbling, the configuration described in FIG. 7 can be implemented. The angled arm 108, in addition to the angled surfaces 706 and 708 interlock with corresponding angled surfaces in angled arm 108. Since arm 108 is angled greater than 90 deg, gravity ensures a line to line fit with tapered surfaces 706 and 708 between angled arm 108 and VESA hinge bar 700 during installation. Set screw 702 ensures a strong mechanical attachment. In a scenario where the screw falls out, gravity keeps the parts attached. The line-to-line fit of surfaces 706 and 708 reduce display wobble by eliminating un-needed clearance between VESA hinge bar 700 and the angle arm 108.

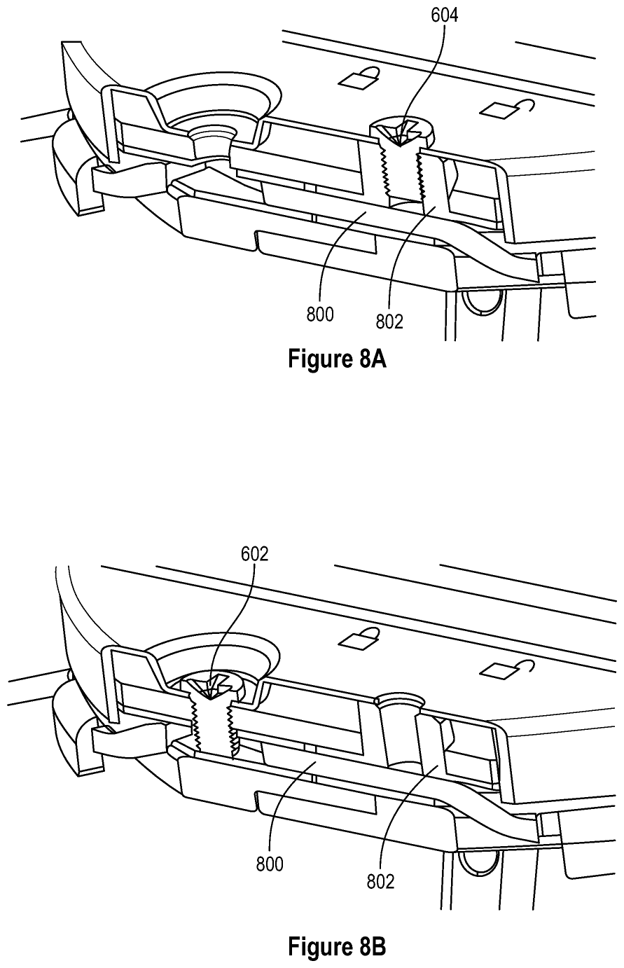

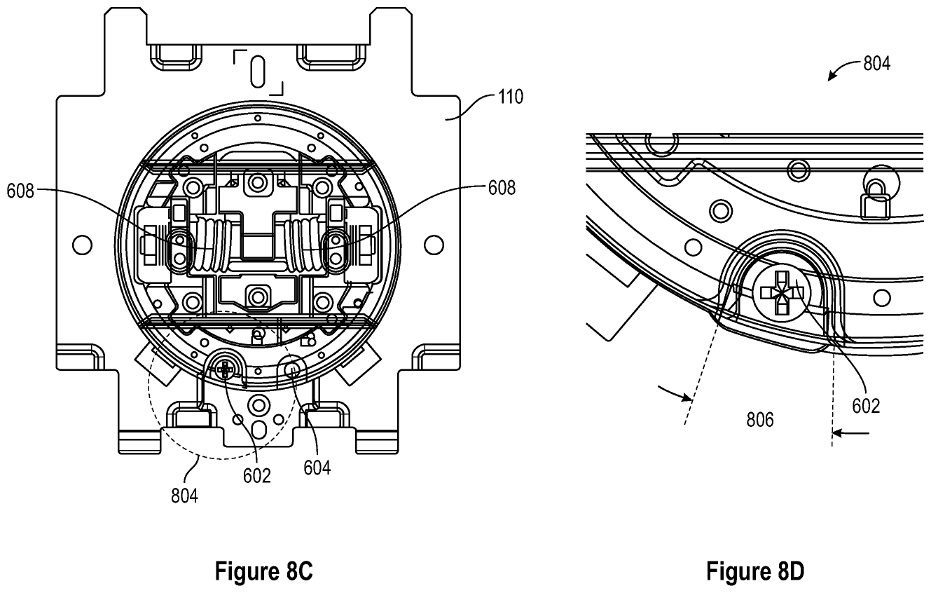

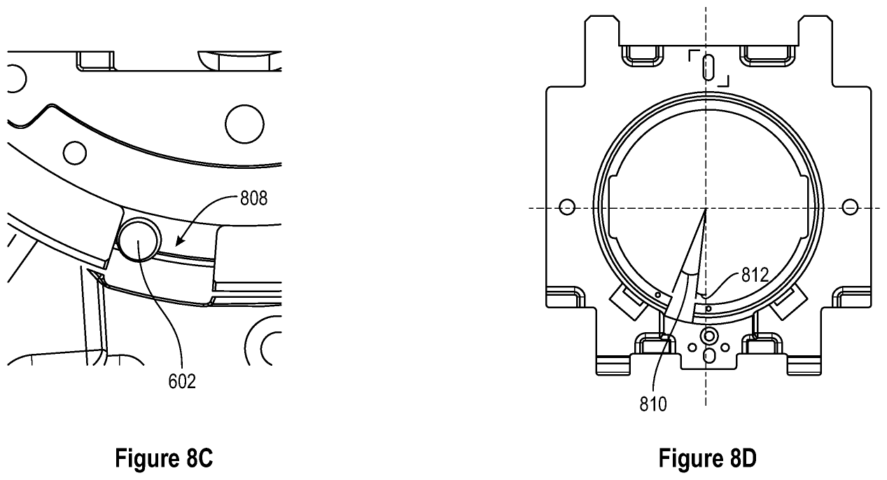

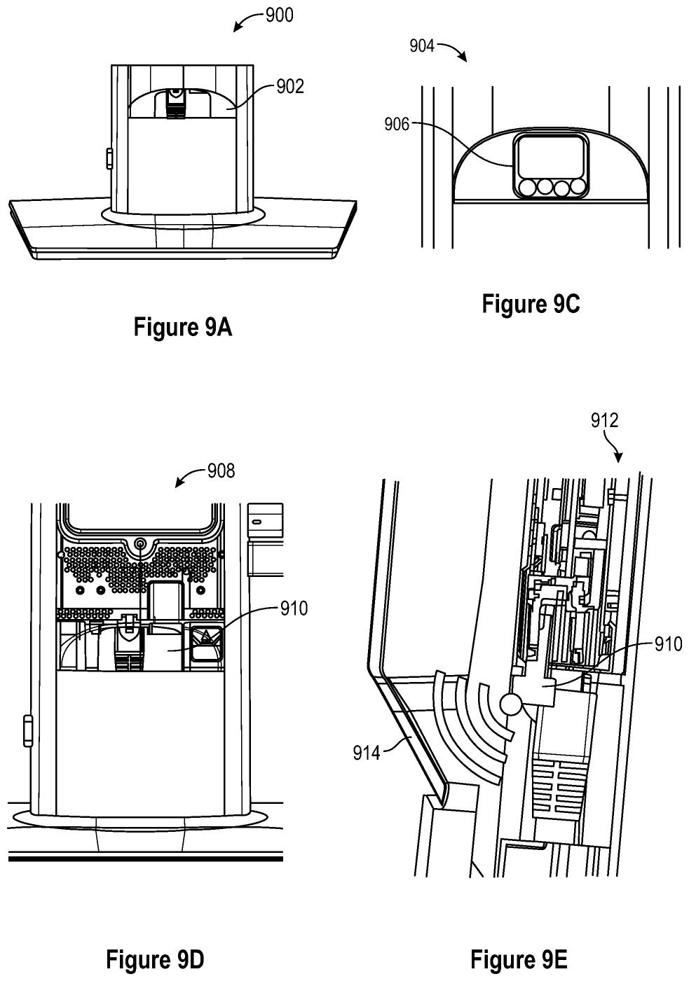

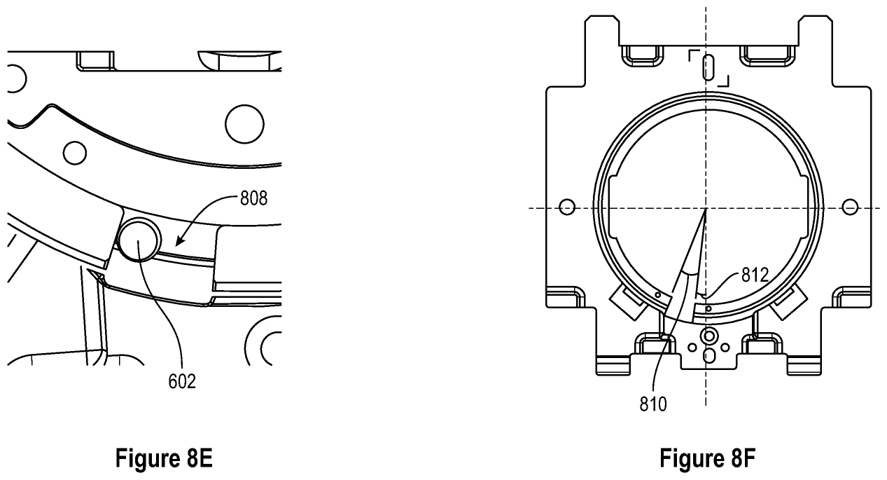

FIG. 8A illustrates a cross sectional view of VESA assembly 110 in an unlock position 604. Implementations provide for VESA assembly 110 to include a VESA bracket 800 and a front friction ring 802. When in unlock position 604, the set screw threads into the front friction ring 802 and VESA bracket 800 is allowed to rotate freely.

FIG. 8B illustrates a cross sectional view of VESA assembly 110 in a lock position 602. When in lock position 602, the set screw engages the VESA bracket 800 to prevent rotation of the display 102.

FIG. 8C shows a rear view of a section of VESA assembly 110 with a lock and unlock positions for display rotation. As discussed, the lock position 602 and unlock position 604 are provided in VESA assembly 110. FIG. 8C further shows that internal hinge 608 can be implemented as a pair of hinges 608, with a hinge 608 on either side of VESA hinge bar 700. A view 804 is shown in FIG. 8D.

FIG. 8D shows a rear view of VESA assembly 110 with a set screw 806 in a lock position 602. When set screw 806 is set in place as described in FIG. 8A, a plus or minus angle of rotation 808 can be provided. For example, angle of rotation 808 can be plus or minus four degrees.

FIG. 8E illustrates a rear view of a section of VESA assembly 110 with a display rotation locking slot 808. As discussed, an angle of rotation 808 can be provided. For example, when the VESA bracket rotates four degrees, the set screw 806 comes in contact with an edge of display rotation locking slot 808, and rotation is stopped.

FIG. 8F illustrates a rear view of VESA assembly 110 with a display rotation locking slot 808. The rotation locking slot 808 need not be in the center of the VESA assembly 110. As shown, implementations provide for rotation locking slot 808 to be off center.

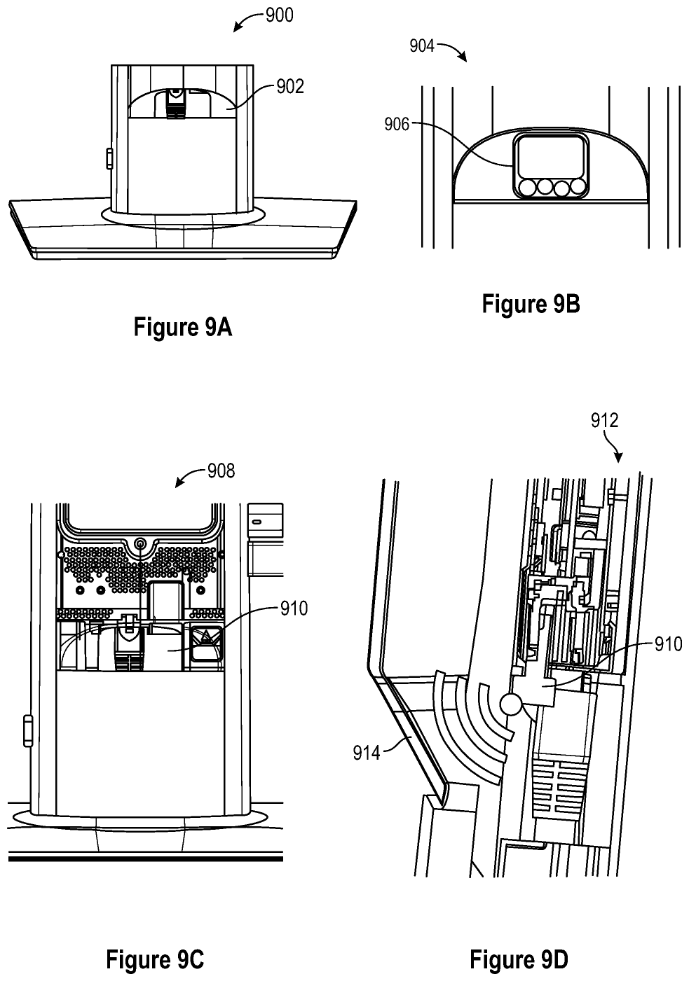

FIG. 9A shows a front view of a section of riser assembly 110 that includes a rectangular pass through slot 900. The rectangular pass through slot 900 in the riser assembly can support a minimized HAS stand 100 height, provide for cable management, provide an airflow inlet for the computing cartridge assembly 120, and provide wireless transmission such as for a wireless keyboard/mouse. An example size of rectangular pass through slot 900 is 26 mm by 30 mm.

FIG. 9B shows a front view of a section of riser assembly 110 that includes rectangular pass through slot 900 and various interconnections 902. The interconnections 902 can be cables connecting the display 102 to the compute cartridge assembly 120 and they could be cables from display 102 passing directly through the stand 100 (e.g., display power cable) The interconnections 902 can include a power plug, type A connections, type C connections, display connections, etc.

FIG. 9C shows a front exposed view of a section of riser assembly 110 that includes dongle 904 for wireless communication. For example, the dongle 904 can be used to communicate to a keyboard/mouse or other devices. The dongle 904 can be located directly or indirectly behind the rectangular pass through slot 900. The dongle 804 can be included with the computing cartridge assembly 120.

FIG. 9D shows a cross sectional view of a section of riser assembly 110 with a dongle, wireless communication, and airflow. The rectangular pass through slot 900 of the riser assembly 110 can provide wireless transmission 906 from dongle 904. Airflow 908 can be accommodated for the computing cartridge assembly 120.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

What is claimed is:

1. A height adjustable stand (HAS) for a display comprising:
a base;
a riser assembly connected to the base, wherein the connection is angled greater than 90 degrees from vertical of the HAS;
a lift plate in the riser assembly that includes an arm, wherein the arm is angled greater than 90 degrees from vertical of the HAS, the lift plate providing vertical travel for the display; and
a VESA assembly that includes a mating component that fits into the opening of the arm, the VESA assembly including an internal hinge that provides tilt for the display.

2. The height adjustable stand (HAS) of claim 1, wherein the height of the HAS is from 360 mm to 420 mm.

3. The height adjustable stand (HAS) of claim 1, wherein the angle of the connection with the riser assembly and the base is greater than 90 degrees.

4. The height adjustable stand (HAS) of claim 1, wherein the angle of arm from vertical of the HAS is from 95 to 140 degrees.

5. The height adjustable stand (HAS) of claim 1, wherein the mating component is angled into the opening of the arm and secured with a set screw to prevent display wobble.

6. The height adjustable stand (HAS) of claim 1, wherein the internal hinge provides for plus and minus degree tilt of the display.

7. The height adjustable stand (HAS) of claim 1, wherein the riser assembly accepts a computing cartridge assembly.

8. The height adjustable stand (HAS) of claim 1 further comprising a locking component to lock rotation of the display.

9. The height adjust stand (HAS) of claim 1, wherein the riser assembly includes a pass through slot to support a computing cartridge assembly.

10. The height adjust stand (HAS) of claim 1, wherein the base, riser assembly, VESA assembly, and a computing cartridge assembly are modular and interchangeable with other like components.

11. An all in one computing device comprising:
a display;
a computing cartridge assembly; and a
height adjustable stand (HAS) for a display comprising:
a base;
a riser assembly connected to the base, wherein the connection is angled greater than 90 degrees from vertical of the HAS, wherein the riser assembly connects to the computing cartridge assembly;
a lift plate in the riser assembly that includes an arm, wherein the arm is angled greater than 90 degrees from vertical of the HAS, the lift plate providing vertical travel for the display; and
a VESA assembly that includes a mating component that fits into the opening of the arm, the VESA assembly including an internal hinge that provides tilt for the display.

12. The all in one computing device of claim 11, wherein the height of the HAS is from 360 mm to 420 mm.

13. The all in one computing device of claim 11, wherein the angle of the connection with the riser assembly and the base is greater than 90 degrees.

14. The all in one computing device of claim 11, wherein the angle of the arm from vertical of the HAS is from 95 to 140 degrees

15. The all in one computing device of claim 11, wherein the mating component is angled into the opening of the arm and secured with a set screw to prevent display wobble.

16. The all in one computing device of claim 11, wherein the internal hinge provides for plus and minus degree tilt of the display.

17. The all in one computing device of claim 11, wherein the computing cartridge assembly is attached into the back of the riser assembly.

18. The all in one computing device of claim 11 further comprising a locking component to lock rotation of the display.

19. The all in one computing device of claim 11, wherein the riser assembly includes a pass through slot to support a computing cartridge assembly.

20. The all in one computing device of claim 11, wherein base, riser assembly, VESA assembly, and a computing cartridge assembly are modular and interchangeable with other like components.
